(19) United States
(12) Patent Application Publication
(10) Pub. No.: US 2007/0070966 A1
(43) Pub. Date: Mar. 29, 2007

(54) Wireless USB host, wireless USB device, method of providing function of dual role device host, and method of performing function of dual role device host

(75) Inventors: Hyun-ah Sung, Seoul (KR); Dae-gyu Bae, Suwon-si (KR); Jin-woo Hong, Suwon-si (KR); So-hoon Moon, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/529,534

(22) Filed: Sep. 29, 2006

(30) Foreign Application Priority Data
Sep. 29, 2005 (KR) 10-2005-0091347

(51) Int. Cl. H04Q 7/24

(52) U.S. Cl. 370/338

(57) ABSTRACT

A wireless USB host, a wireless USB device, a method of providing the function of a dual role device host, and a method of performing the function of the dual role device host are provided. The wireless USB host includes a searching unit which determines whether a wireless USB device can create a beacon and has transmitted a request to perform the role of a host based on a predetermined information packet received through a default link in a wireless USB point-to-point dual role device communication environment. The wireless USB host also includes a channel information packet creating unit which creates a channel information packet including at least one of packet synchronization information and channel time allocation information for setting a reverse link based on the determined result, and a transmitting/receiving unit which transmits the channel information packet based on the packet synchronization information, sets the reverse link to the wireless USB device based on the channel information packet, and performs data communication with the wireless USB device through the reverse link.

### CROSS-REFERENCE TO RELATED APPLICATION

This application claims priority from Korean Patent Application No. 10-2005-091347 filed on Sep. 29, 2005, in the Korean Intellectual Property Office, the disclosure of which is incorporated herein by reference in its entirety.

### BACKGROUND OF THE INVENTION

1. Field of the Invention

Methods and apparatuses consistent with the present invention relate to a wireless universal serial bus, and more particularly, to a wireless Universal Serial Bus (USB) host, a wireless USB device, a method of providing the function of a dual role device host, and a method of performing the function of a dual role device host.

2. Description of the Related Art

With the development of communication and network techniques, in recent years, wired network environments using a wire medium, such as a coaxial cable or an optical cable, have changed into wireless network environments using radio waves in various frequency bands.

Such wireless networks are classified into two types: a wireless network which includes an access point 110 as shown in FIG. 1; and a wireless network which does not include an access point as shown in FIG. 2. The wireless network which includes the access point 110 is referred to as an ‘infrastructure-mode wireless network’. In the infrastructure-mode wireless network, the access point 110 functions to relay data in order to connect a wireless network to a wire network or to perform communication among wireless network apparatuses belonging to a wireless network. Therefore, in the infrastructure-mode wireless network environment, all data is transmitted through the access point 110.

The wireless network which does not include an access point is referred to as an ‘ad-hoc-mode wireless network’. In the ad-hoc-mode wireless network, data packets are directly transmitted among wireless network devices belonging to a single wireless network, without passing through a relay apparatus, such as an access point.

Ad-hoc-mode wireless networks are divided into two types. In one type of ad-hoc-mode wireless network, one wireless network apparatus which is arbitrarily selected from wireless network apparatuses belonging to a single wireless network serves as an arbitrator for allocating data packet transmission time (hereinafter, referred to as ‘channel time’) to the other wireless network apparatuses, and the other wireless network apparatuses transmit the data packets in the channel time allocated thereto.

In the other type of ad-hoc-mode wireless network, a wireless network apparatus, serving as an arbitrator, is not provided, and all the wireless network apparatuses can transmit data packets by mutual agreement therebetween whenever they want to transmit the data packets.

Wireless interfaces for connecting network apparatuses are needed to perform communication in a wireless network environment. These wireless interfaces include, for example, IrDA and Bluetooth. In recent years, research has been conducted on a wireless wireless USB, which is an advanced version of USB, a related art wire interface.

The following is a brief description of advantages of the USB. A serial port has a maximum speed of 100 Kbps, but the USB can support a data transmission speed of 12 Mbps. In addition, when the USB is used as an interface between network apparatuses, it is possible to reduce the number of adapters and thus to simplify the structure of the network apparatus. Further, the use of the USB makes it unnecessary to install additional software or hardware when peripheral apparatuses are connected to a personal computer (PC). In addition, since all peripheral apparatuses are connected to the PC using the same connectors, it is possible to considerably reduce the number of ports. Also, the USB can be easily installed, and it is possible to reduce the size of a portable PC.

FIG. 3 is a diagram showing a dual role device that performs the functions of a host and a device in the related art wireless USB environment. Also, FIG. 3 shows an apparatus driven in a point-to-point mode.

Wireless USBs are classified into three types according to the degree of recognition on a mechanism of a physical layer, that is, a self-beaconing device, a directed-beaconing device, and a non-beaconing device. The self-beaconing device completely recognizes a physical layer protocol and can perform all functions related to a beacon. The directed-beaconing device does not recognize a physical layer protocol and thus recognizes adjacent apparatuses with respect to the proper use of a beacon, depending on a host. In addition, since the non-beaconing device has low transmission power and receiving sensitivity, it does not affect or is not affected by adjacent apparatuses that are not detected by a host.

FIG. 3 shows a default link formed between a host and a device when one of two apparatuses provided in a network functions as the host and the other apparatus functions as the device. The host searches for a device capable of providing the function of a point-to-point dual role device (DRD) in the network. When the device is searched, the host sets a reverse link to the device. That is, the host sets a reverse link to the self-beaconing device. When the reverse link is set, the device performs the function of the host, and the host performs the function of the device.

In this case, a device performing the function of a host first searches for a device which provides the function of a point-to-point dual role device host in the network, that is, the self-beaconing device. When the device searched in the network does not provide a beacon, that is, when a non-beaconing device is searched in the network, the device cannot provide the function of a point-to-point dual role device host. When the reverse link is set, the device performing the function of a host should create a beacon and broadcast it.

Therefore, a method of making a device that is unable to provide a beacon function as a point-to-point dual role device host is needed.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a technique for forming a reverse link between a host and a device by allowing the host to allocate channel time through a default link in a wireless universal serial bus point-to-point network environment.

The present invention also provides a technique for making a device that is unable to provide a beacon function as a dual role device host.

According to an aspect of the invention, there is provided a wireless USB host including a searching unit which determines whether a wireless USB device can create a beacon and requests the role of a host on the basis of a predetermined information packet received through a default link in a wireless USB point-to-point dual role device communication environment; a channel information packet creating unit which creates a channel information packet including at least one of packet synchronization information and channel time allocation information for setting a reverse link on the basis of the searched result; and a transmitting/receiving unit which transmits the channel information packet on the basis of the packet synchronization information, sets the reverse link to the wireless USB device on the basis of the channel information packet, and performs data communication with the wireless USB device through the reverse link.

According to another aspect of the invention, there is provided a wireless USB device including a request packet creating unit which creates a request packet including a host role request flag in a wireless USB point-to-point dual role device communication environment; a packet analyzing unit which analyzes a channel information packet received from a wireless USB host in response to the request packet; a management packet creating unit which creates a management packet including channel time allocation information and information on a transmission direction of data on the basis of the analyzed result; and a transmitting/receiving unit which sets a reverse link to the wireless USB host on the basis of the analyzed result, transmits the management packet through the reverse link, and performs data communication with the wireless USB host on the basis of the channel time allocation information and the information on the transmission direction of data.

According to still another aspect of the invention, there is provided a method of providing the function of a dual role device host, the method including determining whether a wireless USB device can create a beacon and requests the role of a host on the basis of a predetermined information packet received through a default link in a wireless USB point-to-point dual role device communication environment; creating a channel information packet including at least one of packet synchronization information and channel time allocation information for setting a reverse link on the basis of the searched result; and transmitting the channel information packet on the basis of the packet synchronization information, setting the reverse link to the wireless USB device on the basis of the channel information packet, and performing data communication with the wireless USB device through the reverse link.

According to yet another aspect of the invention, there is provided a method of performing the function of a dual role device host, the method including creating a request packet including a host role request flag in a wireless USB point-to-point dual role device communication environment; analyzing a channel information packet received from a wireless USB host in response to the request packet; creating a management packet including channel time allocation information and information on a transmission direction of data on the basis of the analyzed result; and setting a reverse link to the wireless USB host on the basis of the analyzed result, transmitting the management packet through the reverse link, and performing data communication with the wireless USB host on the basis of the channel time allocation information and the information on the transmission direction of data.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a wireless network in an infrastructure mode;

FIG. 2 is a diagram illustrating a wireless network in an ad-hoc mode;

FIG. 3 is a diagram illustrating a dual role device that performs the functions of a host and a device in a related art wireless USB environment;

FIG. 4 is a diagram illustrating a wireless USB system formed of a dual role device according to an exemplary embodiment of the invention;

FIG. 5 is a diagram illustrating a request packet according to an exemplary embodiment of the invention;

FIG. 6 is a diagram illustrating the arrangement of wireless USB channels according to an exemplary embodiment of the invention;

FIG. 7 is a diagram illustrating a channel information packet according to an exemplary embodiment of the invention;

FIG. 8 is a diagram illustrating a header of a channel information packet according to an exemplary embodiment of the invention;

FIG. 9 is a block diagram illustrating a wireless USB host according to an exemplary embodiment of the invention;

FIG. 10 is a block diagram illustrating a wireless USB device according to an exemplary embodiment of the invention;

FIG. 11 is a flow chart illustrating a process of providing the function of a dual role device host according to an exemplary embodiment of the invention; and

FIG. 12 is a flow chart illustrating a process of performing the function of a dual role device host according to an exemplary embodiment of the invention.

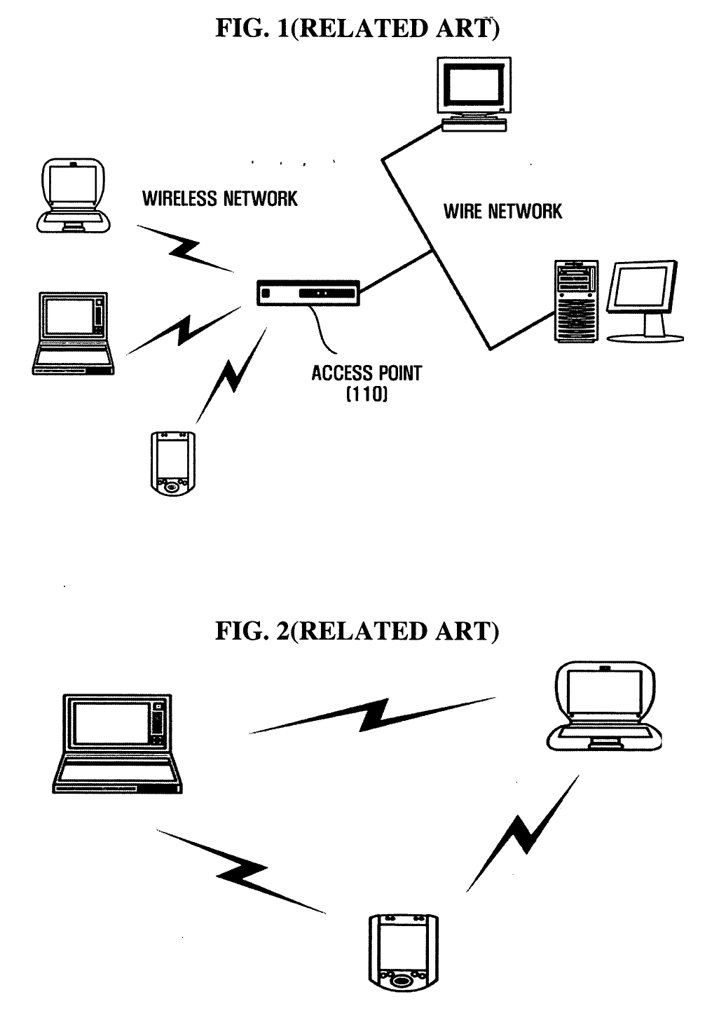

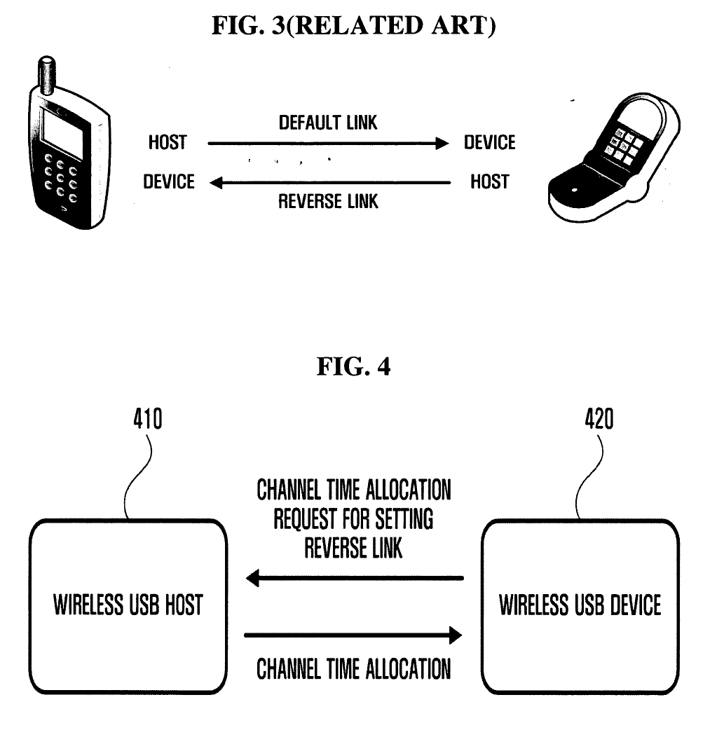

### DETAILED DESCRIPTION OF EXEMPLARY EMBODIMENTS OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the exemplary embodiments of the present invention will only be defined by the appended claims. Like reference numerals refer to like elements throughout the specification.

Hereinafter, exemplary embodiments of the present invention will be described below with reference to the accompanying drawings.

FIG. 4 is a diagram illustrating a wireless USB system composed of a dual role device (hereinafter, referred to as a DRD). As shown in FIG. 4, the wireless USB system includes a wireless USB host 410 and a wireless USB device 420.

In this structure, it is assumed that the wireless USB host 410 performs the function of a dual role device (DRD) host (hereinafter, referred to as a DRD host), and the wireless USB device 420 performs the function of the DRD.

First, the wireless USB host 410 and the wireless USB device 420 performing the functions of the DRDs in a wireless USB environment will be described below.

An apparatus having one transceiver can simultaneously perform the functions of the wireless USB host 410 and the wireless USB device 420 in the wireless USB environment. This is executed by various modes including a combination mode and a point-to-point mode.

In the combination mode, an apparatus performs the function of a device to connect an upstream to one or more individual wireless USB channels, and also performs the function of a host to manage the wireless USB channels. For example, a wireless USB printer that performs the function of a device to connect an upstream to one or more wireless USB channels can provide a wireless USB channel required for connection to a camera.

In the point-to-point mode, two wireless USB dual role devices are connected and function as the host 410 and the device 420, respectively.

In the combination mode, the wireless USB DRD host and the wireless USB DRD are logically separated from each other. In addition, the wireless USB DRD host performs only the function of the wireless USB host 410, and the wireless USB DRD performs only the function of the wireless USB device 420.

In the point-to-point mode, two wireless USB dual role devices connected to each other by one upstream wireless USB link and one downstream wireless USB link form a pair of point-to-point dual role devices. The wireless USB link that is set first is referred to as a default link, and the wireless USB link that is set subsequently is referred to as a reverse link. The pair of point-to-point dual role devices should exist in the same physical layer (Micro-scheduled Management Command (MMC) layer) channel. That is, pairing two point-to-point dual role devices is performed through two stages, a default link setting stage and a reverse link setting stage.

The default link and the reverse link share the same connection context and session context. Therefore, a connection host identifier of the point-to-point dual role device in the default link is the same as that of the point-to-point dual role device in the reverse link. Only the DRD host of the default link can modify the context.

The two stages include a step of searching the point-to-point DRD host in order to set up the default link and a step of pairing the point-to-point dual role devices in order to set up the reverse link.

The step of searching the point-to-point DRD host in order to set up the default link includes a user-instructed discovery process for initial connection and a self-discovery process for reconnection.

The point-to-point dual role device first supplied with power in the initial connection serves as the DRD host. The point-to-point dual role device subsequently supplied with power searches media to find the corresponding point-to-point DRD host. That is, the point-to-point DRD tries to access the point-to-point DRD host.

The host capable of performing the function of the point-to-point dual role device sets a bit of I indicating that the function of the point-to-point dual role device is available to a host information element of an MMC. Then, the device capable of performing the function of the point-to-point dual role device searches the periphery thereof to find out the position of the point-to-point DRD host.

When the point-to-point dual role device completes the connecting process, the point-to-point dual role device obtains the connection context and the default link, and the host searches devices. Then, the point-to-point DRD returns a device capability descriptor having a point-to-point dual role device capability field and a beacon behavior field.

When the point-to-point DRD is searched by the point-to-point DRD host, the point-to-point DRD host starts setting up the reverse link.

In case of reconnection, a pair of point-to-point dual role devices performs the previous function in the previous session, and the pair of point-to-point dual role devices resets the default link through the reconnection process. At that time, when a link between the pair of point-to-point dual role devices is not reset within a predetermined time, the user may set the link therebetween.

In an authentication step of the connection process, after the default link is set up, the point-to-point DRD host allocates its beacon slot and wireless USB cluster to the same physical channel (MAC channel) in the revere link, and sets the point-to-point dual role device availability bit of the host information element included in the MMC to 1. Then, the point-to-point DRD host tries to perform reconnection.

After finding the point-to-point DRD in the default link, the point-to-point DRD host performs the function of the device in the reverse link and starts finding out the position of the host where the connection host identifier in the reverse link is the same as the connection device identifier in the default link.

In the reverse link, the point-to-point dual role device uses the same connection context as that in the default link to perform reconnection. In this case, the authentication step in the connection process is omitted. Then, the point-to-point dual role device uses a security USB control transfer packet SetAddress (0) to perform authentication therebetween.

In the searching step, the point-to-point DRD returns the device capability descriptor having the point-to-point dual role device capability set to zero in the reverse link.

In order to set up a subsequent default link, the point-to-point dual role devices successful in making a pair store the connection context and the corresponding function in the default link.

When the point-to-point DRD supports the function of the point-to-point dual role device, a value of 1 is input to the point-to-point dual role device capability field. On the other hand, when the point-to-point DRD does not support the function of the point-to-point dual role device, a value of 0 is input to the point-to-point dual role device capability field. In addition, a value related to a beacon behavior, such as the creation and transmission of a beacon by the point-to-point dual role device, is input to the beacon behavior field. For example, values 00B, 01B, 10B, and 11B respectively indicating reservation, self-beaconing, directed beaconing, and non-beaconing may be input to the beacon behavior field.

In this exemplary embodiment of the invention, when the wireless USB device 420 does not support the beacon behavior and thus cannot perform the function of the point-to-point DRD host, the wireless USB device 420 returns, to the wireless USB host 410, a device capability descriptor packet having the point-to-point dual role device capability field set to 1 and the beacon behavior field set to 11B. Then, the wireless USB host 410 recognizes that the searched wireless USB device 420 does not support the function of the point-to-point DRD host.

At that time, the wireless USB device 420 uses a device notification packet to request the wireless USB host 410 to allocate channel time for setting the reverse link, and then the wireless USB host 410 allocates the channel time according to the received request. Then, the reverse line is set between the wireless USB host 410 and the wireless USB device 420, and thus the wireless USB device 420 can perform the function of a point-to-point DRD host.

The wireless USB host 410 transmits the channel time allocation packet (channel information packet) in a beacon synchronization period and the wireless USB device 420 transmits a management packet in a distributed reservation protocol (hereinafter, referred to as DRP) period.

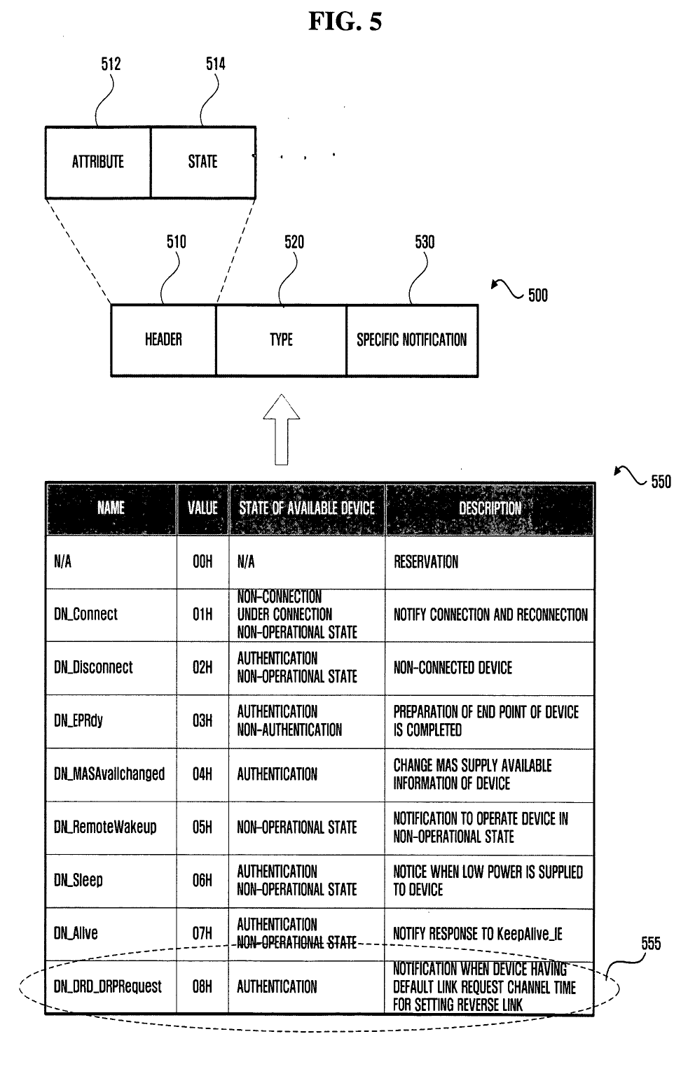

The channel time allocation information, that is, the channel information packet, will be described later in detail with reference to FIG. 5.

FIG. 5 is a diagram illustrating a request packet according to an exemplary embodiment of the invention.

The wireless USB defines a data communication method, called a device notification, performed by a device. The device notification is a small data bit transmitted from a device to a host. The device notification is not frequently generated, but is asynchronous. A device notification mechanism is not used for the exchange of a large amount of information, but is used for a device notification message having a maximum capacity of 32 bites according to a standard. The device notification message is generated in only the time slot allocated by the host. Such a time slot is referred to as a device notification time slot (DNTS). Therefore, the host cannot transmit the device notification message in the DNTS period.

A device notification packet is transmitted to the host by the device. The device notification packet is a first part of a packet frame payload and includes a standard wireless USB header field 510. The header field 510 includes an attribute field 512 and a state field 514.

The payload of the device notification packet includes a type field 520 and a specific notification field 530. One of the values included in a device notification message type table 550 may be input to the type field 520, and the device notification message type table 550 includes the available state of a device that transmits the device notification packet.

In this exemplary embodiment, the wireless USB device 420 transmits a request packet 500 in order to request the function of the point-to-point DRD host, that is, in order to request the channel time allocation for setting the reverse link. The request packet 500 may be transmitted in the form of a device notification packet.

In this exemplary embodiment, before the wireless USB device 420 transmits the request packet 500 to the wireless USB host 410, the wireless USB device 420 inputs DN_DRD_DRPRequest 555 to the type field of the request field 500, which is performed in order to request the channel time allocation for setting the reverse link.

The wireless USB host 410 checks the request packet 500 and allocates channel time for setting the reverse link. Then, the wireless USB host 410 transmits the channel information packet to the wireless USB device 420.

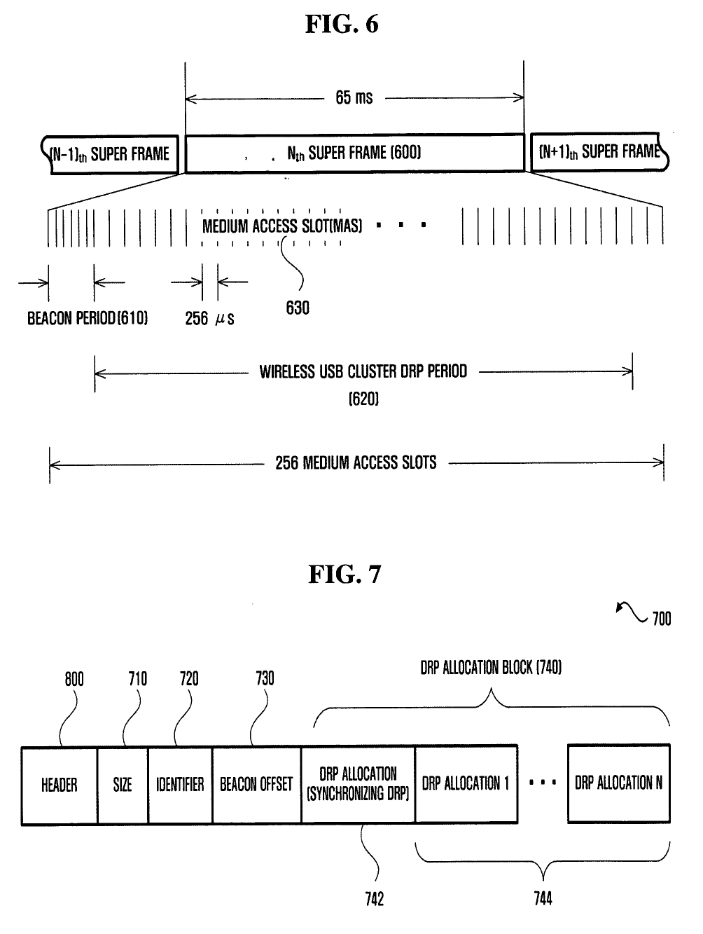

FIG. 6 is a diagram illustrating the arrangement of wireless USB channels according to an exemplary embodiment of the invention.

A channel is a transmission path between nodes, and a wireless physical layer configures wireless transmission in the frequency range by means of compression and a technique for channels. A data link layer arranged above the physical layer compresses or decompresses bit streams of transmitted or received data packets, provides transport protocol information and management information, and processes frame synchronization, flow control, and error control in the physical layer. The data link layer includes logical link control and media access control for managing information through the physical channel.

The wireless USB uses the physical channel and the media access control layer for defining access to the access control layer channel and also uses the beacon for search and distribution control and the DRP for data communication according to the time division multiple access (TDMA) scheme.

As shown in FIG. 6, media access control layer channel time is composed of a super frame 600. The super frame 600 starts from a beacon period 610. The interval of the super frame 600 is 65 ms. The super frame 600 is logically classified into 256 media access slots 630, and the media access slot 630 positioned at a starting point of the super frame 600 is allocated for the beacon period 610.

The wireless USB defines a wireless USB channel capsulized to the super frame 600 through a media access slot reservation set (DRP) of the media access layer. The wireless USB channel is a continuous sequence of MMCs, and the MMC is transmitted by the host through the media access control layer reservation.

The MMC includes host identification information, an I/O control structure, and the time reference of the next MMC in the sequence (link). The capsulized channel provides the structure of a transmission path for data communication between the host and the device existing in the wireless USB cluster. The MMC is used by the host to maintain and control the wireless USB channel. The MMC is a management packet defined by an application, and is mainly composed of specific information elements.

In the wireless USB environment, generally, the wireless USB host 410 performs the function of a point-to-point DRD host by transmitting the beacon in the beacon period 610 of the wireless USB channel period and transmitting the MMC in the wireless USB cluster DRP period. However, in this exemplary embodiment, the wireless USB device 420 does not create the beacon, and thus it cannot perform the function of the point-to-point DRD host. Therefore, in order for the wireless USB device 420 to perform the function of the point-to-point DRD host, a reverse link should be formed between the wireless USB device 420 and the wireless USB host 410, and the channel time should be allocated to the reverse link through the beacon created by the wireless USB device 420. However, the wireless USB device 420 cannot create the beacon.

Therefore, the wireless USB host 410 causes the wireless USB device 420 to perform the function of the point-to-point DRD host by allocating the channel time for the reverse link at the request of the wireless USB device 420 and by transmitting the channel information packet including the channel time allocation information. The channel information packet includes the channel time allocation information for setting the reverse link. The wireless USB host 410 creates the channel information packet and transmits it in the beacon period 610 of the channel time allocation period, and the wireless USB device 420 creates the MMC (management packet) and transmits it in the wireless USB cluster DRP period 620.

FIG. 7 is a diagram illustrating a channel information packet 700 according to an exemplary embodiment of the invention. The channel information packet 700 includes a header 800, a size field 710, an identifier field 720, a beacon offset field 730, and a DRP allocation field block 740.

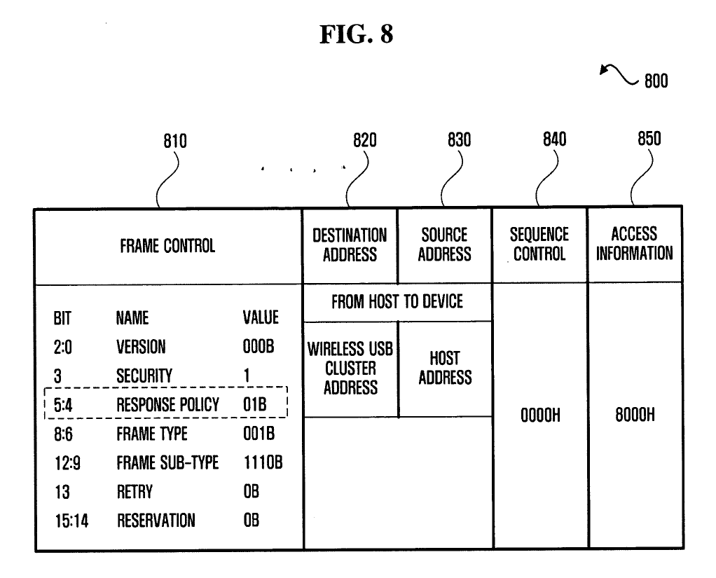

The header 800 includes a flag requesting an immediate response to the wireless USB device 420. The header 800 will be described later with reference to FIG. 8.

The size of the channel information packet 700 is input to the size field 710.

An identifier indicating that the present packet is the channel information packet 700 is input to the identifier field 720.

The beacon offset field 730 is a field used to notify time delayed from the start time of the beacon period, and is used to calculate the position of the DRP allocation field block 740 to synchronize the transmission of the channel information packet 700. That is, the beacon offset field 730 is used for synchronization between the transmission of the channel information packet 700 by the wireless USB host 410 and the transmission of the management packet by the wireless USB device 420.

In the DRP allocation field block 740, a DRP allocation field 742 subsequent to the beacon offset field 730 is a field for informing the start time of the DRP allocation field, and is used to synchronize the transmission and reception of packets. While the DRP allocation field 742 for synchronizing the transmission and reception of packets is being transmitted by the wireless USB host 410, the wireless USB device 420 cannot transmit the management packet and should receive the channel information packet 700 including the DRP allocation field 742. The wireless USB device 420 is operated in this way to perform synchronization without receiving the beacon and to collect channel time allocation information from the wireless USB host 410.

A DRP allocation field 744 of the DRP allocation field block 740 includes, for example, channel time slot allocation information for transmitting the management packet and information on the transmission direction of data. The wireless USB device 420 uses the DRP allocation field 744 to create and transmit the management packet.

Hereinafter, information including at least one of time delayed from the start time of the beacon period 610 input to the beacon offset field 730 and the start time of the DRP allocation field 744 (the start time of the wireless USB cluster DRP period 620) input to the first DRP allocation field 742 is referred to as packet synchronization information.

FIG. 8 is a diagram illustrating a header of the channel information packet according to an exemplary embodiment of the invention. The header 800 of the channel information packet 700 includes a frame control field 810, a destination address field 820, a source address field 830, a sequence control field 840, and an access information field 850.

The frame control field 810 includes a version field, a security field, a response policy field, a frame type field, a frame sub-type field, a retry field, and a reservation field. The structures of the fields other than the response policy field are the same as that of the header of the MMC packet. That is, a value requesting an immediate response is input to the response policy field to cause the wireless USB device 420 having received the DRP information to immediately perform the function of a point-to-point DRD host.

Meanwhile, the frame type field is a field indicating the type of frame. The frame type field shown in FIG. 8 indicates that the present frame is a control frame for the MMC.

The frame sub-type field is a field accompanied when the frame type field is the control frame. The frame sub-type field shown in FIG. 8 indicates an application-specific control frame.

The address of the wireless USB cluster is input to the destination address field 820 of the header 800, and the address of the wireless USB host 410 transmitting the channel information packet 700 is input to the source address field 830. In this exemplary embodiment, in the point-to-point wireless USB environment, since the wireless USB device 420 is included in the wireless USB cluster, the wireless USB device 420 receives the DRP information and performs the function of the point-to-point DRD host.

The sequence control field 840 is not used in the wireless USB. Therefore, the wireless USB device 420 and the wireless USB host 410 input a value of 0000H to the sequence control field 840.

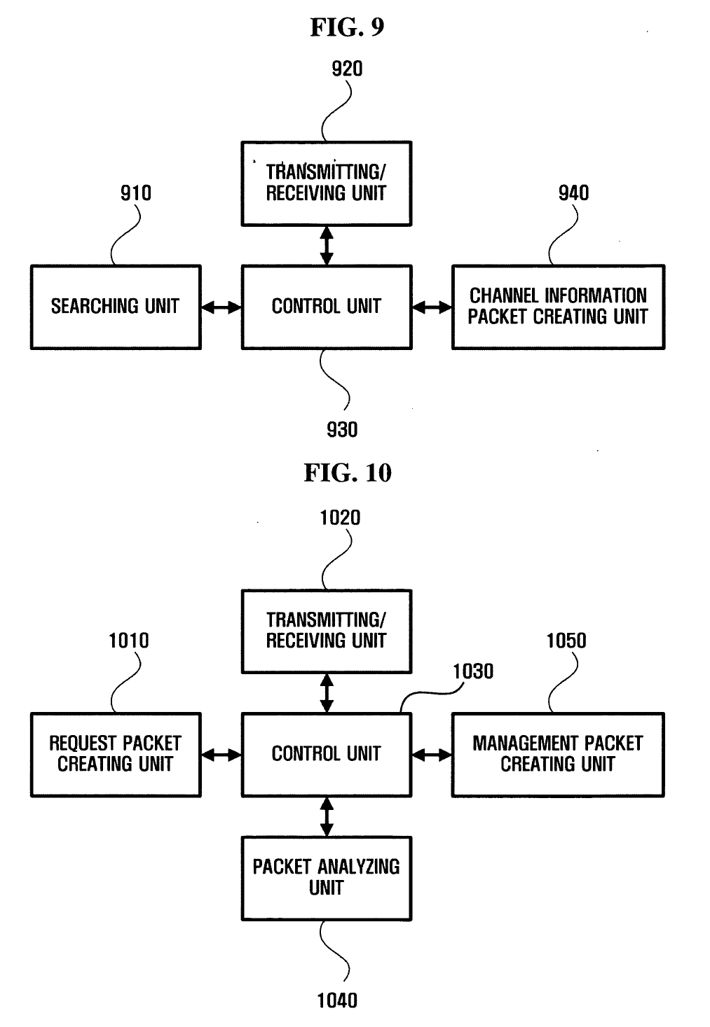

FIG. 9 is a block diagram illustrating a wireless USB host according to an exemplary embodiment of the invention. The wireless USB host 410 includes a searching unit 910, a transmitting/receiving unit 920, a control unit 930, and a channel information packet creating unit 940.

In the invention, the wireless USB host 410 is an apparatus capable of creating and transmitting the beacon. It is assumed that, in the communication environment of the wireless USB point-to-point dual role device, the wireless USB host 410 is supplied with power earlier than the wireless USB device 420, and is operated as the point-to-point host through the default link.

When power is applied to the wireless USB host 410 and then another device (the wireless USB device 420) participates in the network, the wireless USB host 410 uses the management packet to notify the wireless USB device 420 that it can perform the function of the point-to-point DRD host. Here, the management packet includes the MMC defined by the wireless USB standard.

Thereafter, the wireless USB device 420 searches the periphery thereof to find out the position of the wireless USB host 410. Then, connection between the wireless USB host 410 and the wireless USB device 420 is completed, so that a default link is set. The wireless USB host 410 searches the wireless USB device 420. That is, the wireless USB host 410 grasps the performance of the wireless USB device 420. The wireless USB device 420 returns a response packet including information on the performance of the device.

The searching unit 910 determines whether the wireless USB device 420 can support a beacon behavior and can perform the function of the point-to-point DRD host, with reference to the response packet received through the default link in the wireless USB point-to-point dual role device communication environment. The response packet includes at least one of the request packet 500 and the device capability descriptor transmitted by the wireless USB device 420. As described above, the request packet 500 may be a device notification packet including a flag used for the wireless USB device 420 to request the wireless USB host 410 to allocate channel time for the reverse link in order to perform the function of the point-to-point DRD host.

When the wireless USB device 420 supports the beacon behavior, a value of 1 is set to the point-to-point dual role device capability field of the device capability descriptor, and a value of 01B is set to the beacon behavior field. On the other hand, when the wireless USB device 420 does not support the beacon behavior, a value of 11B is set to the beacon behavior field. That is, the searching unit 910 determines whether the wireless USB device 420 can support the beacon behavior using the value input to the point-to-point dual role device capability field of the device capability packet.

The result obtained by the searching unit 910 is transmitted to the control unit 930, and the control unit 930 controls the channel information packet creating unit 940 to create the channel information packet 700.

Then, the channel information packet creating unit 940 creates the channel information packet 700 including packet synchronization information and channel time allocation information. The request packet 500 received by the wireless USB device 420 may include the allocation size of channel time required to set the reverse link. The channel information packet creating unit 940 may create the channel information packet 700 including channel time allocation information having a required size. When the allocated channel time does not exist, the channel information packet creating unit 940 may create the channel information packet 700 corresponding thereto.

The packet synchronization information includes at least one of time delayed from the start time of the beacon period 610 of the channel time period allocated by the set reverse link and the start time of the wireless USB cluster DRP period 620.

The transmitting/receiving unit 920 transmits the channel information packet 700 on the basis of the packet synchronization information, and transmits/receives data to/from the wireless USB device 420, on the basis of the channel time allocation information and the information on the transmission direction of data that are included in the management packet received from the wireless USB device 420.

As shown in FIG. 7, the channel information packet 700 includes the beacon offset field 730 and the DRP allocation field block 740. The transmitting/receiving unit 920 transmits the channel information packet 700 in the beacon period 610, and transmits/receives the management packet to/from the wireless USB device 420 in the wireless USB cluster DRP period 620.

When channel time for the reverse link included in the channel information packet 700 is allocated and the reverse link is set between the wireless USB host 410 and the wireless USB device 420, the wireless USB host 410 performs the function of a point-to-point DRD, and the wireless USB device 420 performs the function of a point-to-point DRD host.

The control unit 930 controls the searching unit 910, the transmitting/receiving unit 920, the channel information packet creating unit 950, and the wireless USB host 410.

FIG. 10 is a block diagram illustrating a wireless USB device according to an exemplary embodiment of the invention. As shown in FIG. 10, the wireless USB device 420 includes a request packet creating unit 1010, a transmitting/receiving unit 1020, a control unit 1030, a packet analyzing unit 1040, and a management packet creating unit 1050.

In the exemplary embodiments of the invention, it is assumed that the wireless USB device 420 does not support the beacon behavior, is supplied with power later than the wireless USB host 410 in the communication environment of the wireless USB point-to-point dual role device, and is operated as a point-to-point DRD through a default link.

When the wireless USB device 420 takes part in the network, the wireless USB device 420 receives the management packet from the wireless USB host 410 and can recognize that the wireless USB host 410 can perform the function of a point-to-point DRD host, on the basis of the management packet received from the wireless USB host 410.

Thereafter, the wireless USB device 420 searches the periphery thereof to find out the position of the wireless USB host 410. Then, when connection between the wireless USB device 420 and the wireless USB host 410 is completed and the default link is set therebetween, the wireless USB host 410 searches the wireless USB device 420. That is, the wireless USB host 410 determines whether the wireless USB device can perform the function of the point-to-point DRD host. Then, the wireless USB device 420 transmits an information packet including the performance thereof.

The request packet creating unit 1010 creates the request packet 500 including channel time allocation request information for the reverse link. The request packet 500 includes a device notification packet. Since the request packet 500 has already been described with reference to FIG. 5, a detailed description thereof will be omitted.

After the request packet 500 is transmitted, the channel information packet 700 is received in response to the request packet 500. The packet analyzing unit 1040 analyzes the received channel information packet 700. The channel information packet 700 received from the wireless USB host 410 includes packet synchronization information and channel time allocation information for setting the reverse link. The packet synchronization information includes at least one of time delayed from the start time of the beacon period 610 of the channel time period allocated by the set reverse link and the start time of the wireless USB cluster DRP period 620.

The management packet creating unit 1050 creates a management packet including channel time allocation information for the wireless USB host 410 and information on the transmission direction of data, on the basis of the result analyzed by the packet analyzing unit 1040, that is, the channel time allocation information of the wireless USB cluster DRP period 620.

The management packet created by the management packet creating unit 1050 includes the MMC defined by the wireless USB standard.

The transmitting/receiving unit 1020 sets the reverse link to the wireless USB host 410 on the basis of the result analyzed by the packet analyzing unit 1040, transmits the management packet through the set reverse link, and transmits/receives data to/from the wireless USB host 410 on the basis of the channel time allocation information and the information on the transmission direction of data included in the management packet.

The transmitting/receiving unit 1020 receives the channel information packet 700 in the beacon period 610, and transmits/receives the management packet or data in the wireless USB cluster DRP period 620.

That is, the transmitting/receiving unit 1020 communicates with the wireless USB host 410 through the reverse link. The wireless USB host 410 performs the function of a point-to-point DRD, and the wireless USB device 420 performs the function of a point-to-point DRD host.

The control unit 1030 controls the request packet creating unit 1010, the transmitting/receiving unit 1020, the packet analyzing unit 1040, the management packet creating unit 1040, and the wireless USB device 420.

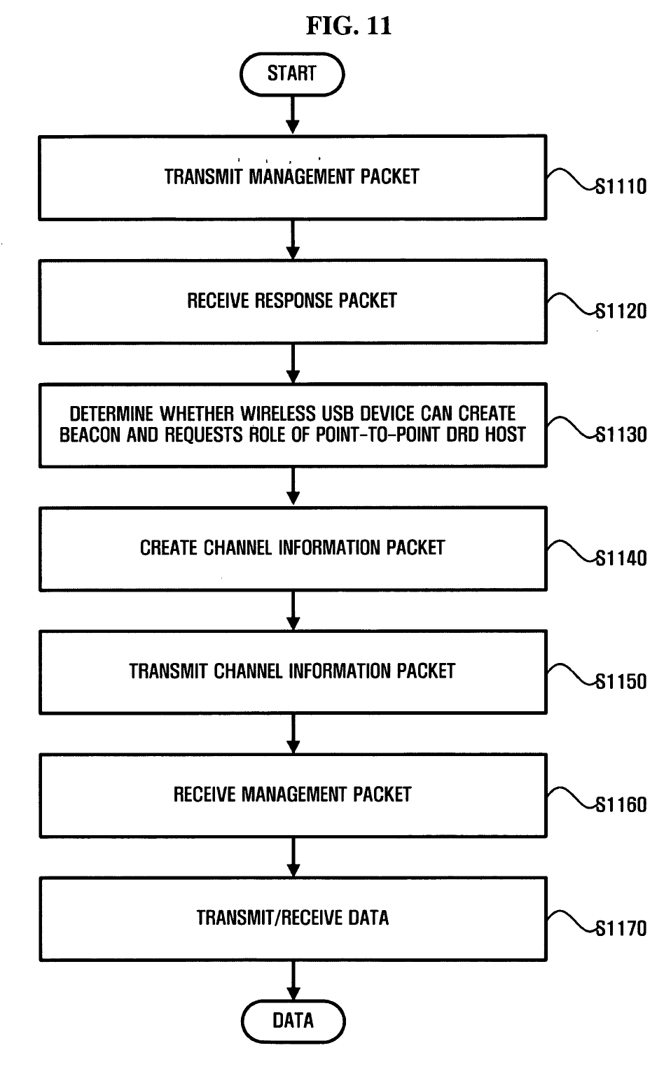

FIG. 11 is a flow chart illustrating a process of providing the function of the dual role device host according to an exemplary embodiment of the invention. More specifically, FIG. 11 is a flow chart illustrating the operation of the wireless USB host 410 to allow the wireless USB device 420 to be operated as a point-to-point DRD host even when the wireless USB device 420 does not support the beacon behavior.

In order to provide the DRD host function to the wireless USB device 420, when the wireless USB device 420 takes part in the network, the wireless USB host 410 transmits, to the wireless USB device 410, a management packet including information indicating that it can perform the function of the point-to-point DRD host (S1110). The management packet includes an MMC defined by the wireless universal serial bus standard.

The transmission of the management packet causes a default link to be set between the transmitting/receiving unit 920 of the wireless USB host 410 and the wireless USB device 420, and the transmitting/receiving unit 920 receives a response packet, which is a response to the management packet, from the wireless USB device 420 (S1120).

The received response packet is transmitted to the searching unit 910, and the searching unit 910 determines whether the wireless USB device can create the beacon and requests the role of a point-to-point DRD host, on the basis of the received response packet (S1130). The response packet includes at least one of the request packet 500 and the device capability descriptor transmitted from the wireless USB device 420. As described above, the request packet 500 may be a device notification packet including a flag used for the wireless USB device 420 to request the wireless USB host 410 to allocate channel time for the reverse link in order to perform the function of the point-to-point DRD host.

Subsequently, the result obtained by the searching unit 910 is transmitted to the control unit 930. After confirming the searched result, the control unit 930 controls a channel information packet creating unit 940 to create the corresponding channel information packet 700.

Then, the channel information packet creating unit 940 creates the channel information packet 700 including, for example, packet synchronization information and channel time allocation information (S1140).

The packet synchronization information includes at least one of the starting time of the wireless USB cluster DRP period 620 and time delayed from the starting time of the beacon period 610 of the channel time period which is allocated through the reverse link set to the wireless USB device 420.

After the channel information packet 700 is created, the transmitting/receiving unit 920 transmits the channel information packet 700 (S1150). When the channel time including the channel information packet 700 is allocated, a reverse link is set between the transmitting/receiving unit 920 and the wireless USB device 420, and the transmitting/receiving unit 920 receives the management packet created by the wireless USB device 420 through the reverse link (S1160).

The received management packet includes channel time allocation information for data transmission/reception and information on the transmission direction of data. The transmitting/receiving unit 920 performs data communication with the wireless USB device 420 on the basis of the management packet (S1170).

The channel information packet 700 may be transmitted in the beacon period 610, and the management packet and data of the wireless USB device 420 may be transmitted or received in the wireless USB cluster DRP period 620.

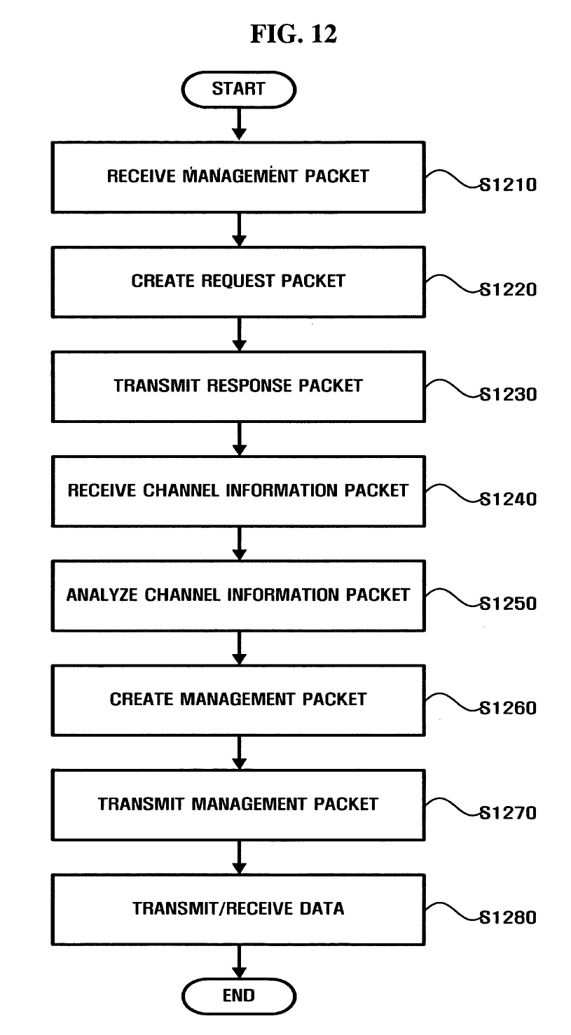

FIG. 12 is a flow chart illustrating a process of performing the function of a dual role device host according to an exemplary embodiment of the invention. More specifically, FIG. 12 is a flow chart illustrating the operation of the wireless USB device 420 creating a management packet using information received from the wireless USB host 410 and transmitting the management packet, thereby performing the function of a point-to-point DRD host.

In order to perform the function of the point-to-point DRD host, the wireless USB device 420 takes part in a wireless USB network and receives from the wireless USB host 410 a management packet including information indicating that the function of the point-to-point DRD host is available (S1210). The management packet includes an MMC defined by the wireless USB standard.

When the management packet is received, the transmitting/receiving unit 1020 of the wireless USB device 420 sets a default link to the wireless USB host 410. Then, the request packet creating unit 1010 of the wireless USB device 420 creates a request packet 500 (S1220).

Subsequently, the transmitting/receiving unit 1020 transmits a response packet in response to the management packet (S1230).

The response packet includes at least one of the request packet 500 and the device capability descriptor. As described above, the request packet 500 may be a device notification packet including a flag used for the wireless USB device 420 to request the wireless USB host 410 to allocate channel time for the reverse link in order to perform the function of the point- to-point DRD host.

In this exemplary embodiment, the wireless USB device 420 supports the function of a point-to-point DRD, but does not support the function of a point-to-point DRD host. Therefore, in the device capability descriptor, the point-to-point dual role device capability field can be set to ‘1’, and the beacon behavior field can be set to 11B.

Then, the transmitting/receiving unit 1020 of the wireless USB device 420 receives from the wireless USB host 410 the channel information packet 700 including packet synchronization information and channel time allocation information (S1240).

The received channel information packet 700 is transmitted to the packet analyzing unit 1040, and the packet analyzing unit 1040 analyzes the received channel information packet 700 (S1250).

When the channel information packet 700 is completely analyzed by the packet analyzing unit 1040, a reverse link is set between the transmitting/receiving unit 1020 and the wireless USB host 410 according to the analyzed result. Then, the management packet creating unit 1050 creates a management packet on the basis of the analyzed result (S1260). That is, the management packet creating unit 1050 creates a management packet including channel time allocation information for the wireless USB host 410 and information on the transmission direction of data on the basis of the channel time allocation information in the wireless USB cluster DRP period 620. The management packet includes an MMC defined by the wireless USB standard.

After the management packet is created, the transmitting/receiving unit 1020 transmits the management packet through the reverse link (S1270) and performs data communication with the wireless USB host 410 on the basis of the channel time allocation information and the information on the transmission direction of data included in the management packet (S1280).

In this case, the transmitting/receiving unit 1020 of the wireless USB device 420 can receive the channel information packet 700 in the beacon period 610 and can transmit the management packet and perform data communication in the wireless USB cluster DRP period 620.

As described above, according to the wireless USB host, the wireless USB device, the method of providing the function of a dual role device host, and the method of performing the function of the dual role device host of the exemplary embodiments of the invention, the following effects can be obtained.

First, it is possible to set a reverse link between a host and a device by making the host allocate channel time through a default link in a wireless USB point-to-point communication environment.

Second, it is possible to make an apparatus that is unable to provide a beacon perform the function of a dual role device host in a wireless USB point-to-point communication environment.

While the exemplary embodiments of the invention have been described above with reference to the accompanying drawings, it will be understood by those skilled in the art that various modifications and changes of the exemplary embodiments of the invention can be made without departing from the scope and spirit of the invention. Therefore, it should be understood that the above-described exemplary embodiments are not restrictive, but illustrative in all aspects.

What is claimed is:

1. A wireless Universal Serial Bus (USB) host comprising:
a searching unit which determines whether a wireless USB device can create a beacon and whether the wireless USB device requests the role of a host based on a predetermined information packet received through a default link in a wireless USB point-to-point dual role device communication environment;
a channel information packet creating unit which creates a channel information packet comprising at least one of packet synchronization information and channel time allocation information for setting a reverse link based on a determination result received from the searching unit; and
a transmitting and receiving unit which transmits the channel information packet based on the packet synchronization information, sets the reverse link to the wireless USB device based on the channel information packet, and performs data communication with the wireless USB device through the reverse link.

2. The wireless USB host of claim 1, wherein the information packet comprises at least one of a device notification packet and a device capability descriptor packet transmitted by the wireless USB device.

3. The wireless USB host of claim 1, wherein the packet synchronization information comprises at least one of time delayed from a starting time of a beacon period of a channel time period allocated by the reverse link and a starting time of a wireless USB cluster distributed reservation protocol (DRP) period.

4. The wireless USB host of claim 1, wherein the transmitting and receiving unit transmits the channel information packet to the wireless USB device in the beacon period of the channel time period allocated by the reverse link.

5. The wireless USB host of claim 1, wherein the transmitting and receiving unit transmits or receives data in the wireless USB cluster DRP period of the channel time period allocated by the reverse link.

6. A wireless Universal Serial Bus (USB) device comprising:
a request packet creating unit which creates a request packet comprising a host role request flag in a wireless USB point-to-point dual role device communication environment;
a packet analyzing unit which analyzes a channel information packet received from a wireless USB host in response to the request packet;
a management packet creating unit which creates a management packet comprising channel time allocation information and information on a transmission direction of data based on an analysis result obtained by the packet analyzing unit; and
a transmitting and receiving unit which sets a reverse link to the wireless USB host based on the analysis result, transmits the management packet through the reverse link, and performs data communication with the wireless USB host based on the channel time allocation information and the information on the transmission direction of data.

7. The wireless USB device of claim 6, wherein the channel information packet comprises at least one of packet synchronization information and channel time allocation information for setting the reverse link.

8. The wireless USB device of claim 7, wherein the packet synchronization information comprises at least one of a time delayed from a starting time of a beacon period of a channel time period allocated by the reverse link and a starting time of a wireless USB cluster distributed reservation protocol period.

9. The wireless USB device of claim 6, wherein the management packet comprises a micro scheduled management command packet defined by a wireless universal serial bus standard.

10. The wireless USB device of claim 6, wherein the transmitting and receiving unit receives the channel information packet from the wireless USB host in a beacon period of a channel time period allocated by the reverse link.

11. The wireless USB device of claim 6, wherein the transmitting and receiving unit transmits the management packet and performs data communication in a wireless USB cluster distributed reservation protocol period of a channel time period allocated by the reverse link.

12. A method of providing the function of a dual role device host, the method comprising:
determining whether a wireless Universal Serial Bus (USB) device can create a beacon and whether the USB device requests the role of a host based on a predetermined information packet received through a default link in a wireless USB point-to-point dual role device communication environment;
creating a channel information packet comprising at least one of packet synchronization information and channel time allocation information for setting a reverse link based on a result of the determining; and
transmitting the channel information packet based on the packet synchronization information, setting the reverse link to the wireless USB device based on the channel information packet, and performing data communication with the wireless USB device through the reverse link.

13. The method of claim 12, wherein the information packet comprises at least one of a device notification packet and a device capability descriptor packet transmitted by the wireless USB device.

14. The method of claim 12, wherein the packet synchronization information comprises at least one of time delayed from a starting time of a beacon period of a channel time period allocated by the reverse link and a starting time of a wireless USB cluster distributed reservation protocol (DRP) period.

15. The method of claim 12, wherein the transmitting of the channel information packet comprises transmitting the channel information packet to the wireless USB device in a beacon period of a channel time period allocated by the reverse link.

16. The method of claim 12, wherein the performing of the data communication comprises transmitting and receiving data in a wireless USB cluster DRP period of a channel time period allocated by the reverse link.

17. A method of performing the function of a dual role device host, the method comprising:
creating a request packet comprising a host role request flag in a wireless Universal Serial Bus (USB) point-to-point dual role device communication environment;
analyzing a channel information packet received from a wireless USB host in response to the request packet;
creating a management packet comprising channel time allocation information and information on a transmission direction of data based on a result of the analyzing; and
setting a reverse link to the wireless USB host based on the result of the analyzing, transmitting the management packet through the reverse link, and performing data communication with the wireless USB host based on the channel time allocation information and the information on the transmission direction of data.

18. The method of claim 17, wherein the channel information packet comprises at least one of packet synchronization information and channel time allocation information for setting the reverse link.

19. The method of claim 18, wherein the packet synchronization information comprises at least one of time delayed from a starting time of a beacon period of a channel time period allocated by the reverse link and a starting time of a wireless USB cluster distributed reservation protocol (DRP) period.

20. The method of claim 17, wherein the management packet comprises a micro scheduled management command packet defined by a wireless USB standard.

21. The method of claim 17, wherein the performing of the data communication comprises receiving the channel information packet from the wireless USB host in a beacon period of a channel time period allocated by the reverse link.

22. The method of claim 17, wherein the performing of the data communication comprises transmitting the management packet to the wireless USB host in a wireless USB cluster distributed reservation protocol period and performing data communication with the wireless USB host.
